(19) United States
(12) Patent Application Publication
(10) Pub. No.: US 2024/0358578 A1
(43) Pub. Date: Oct. 31, 2024

(54) MASSAGE DEVICE COMPRISING IMPROVED INDEPENDENTLY OPERABLE LEG MASSAGE UNIT

(71) Applicant: BODYFRIEND CO., LTD., Seoul (KR)

(72) Inventors: Woong Chul KANG, Seoul (KR); Ju Song HUR, Seoul (KR); Beom Seok LEE, Seoul (KR)

(21) Appl. No.: 18/277,981

(22) PCT Filed: Aug. 5, 2022
(86) PCT No.: PCT/KR2022/011703

§ 371 Date: Aug. 18, 2023

(30) Foreign Application Priority Data
Jun. 3, 2022 (KR) 10-2022-0067897
Jul. 15, 2022 (KR) 10-2022-0087300

(51) Int. Cl. A61H 7/00

(52) U.S. Cl. CPC A61H 7/004; A61H 2201/0119; A61H 2201/0196; A61H 2205/10

(57) ABSTRACT

The present invention relates to a massage device including: a leg connection frame; a first leg massage part connected to the leg connection frame in a rotatable manner and accommodating one leg of a user; a second leg massage part connected to the leg connection frame to be spaced apart from the first leg massage part, provided to be rotated independently from the first leg massage part, and accommodating the other leg of the user; a center support bracket provided on the leg connection frame, rotatably supporting the inner side of the first leg massage part and the inner side of the second leg massage part; and a side support bracket provided on the leg connection frame, rotatably supporting the outer side of the first leg massage part and the outer side of the second leg massage part.

### TECHNICAL FIELD

The present invention relates to a massage device including an improved independent-motion leg massage part, and more specifically, to a massage device which includes a safety sensor module between leg massage parts, thereby preventing accidents.

### BACKGROUND ART

Massage is a medical assistance therapy for controlling a user's physical modulation, helping blood circulation, and relieving fatigue of the user by applying various types of mechanical stimulation to a portion of the body, such as massaging, pressing, pulling, tapping, or moving a portion of the body of the user.

The growth in a massage demand caused an increase in demand for massage devices or massage devices, which provide an artificial massage function, because of economic feasibility and temporal reasons. That is, as the demand for relieving fatigue or stress is increased while loosening the agglomerated muscles through massage, various mechanical massage devices for time and cost efficiencies are being released.

Recently, there is an increase in interest in health of people, and the massage device is changing as an electronic device providing various additional functions, and/or medical functions from a device simply providing a massage function. Accordingly, researches on how to efficiently control a massage device are continued.

Specifically, since users may have different regions to get a massage and may have different types of desired stimulation, research activities on devices and methods that provide an optimized form of massage for each user are increasing.

For instance, Korean Patent Publication No. 10-2020-0100561 discloses a massage device which is divided into a first leg massage part in which a right leg is accommodated and a second leg massage part in which a left leg is accommodated, and in which the first leg massage part and the second leg massage part are operated independently.

In the meantime, as the leg massage part which is independently operated is independently operated, there is a problem that a portion of the body of a user may be caught between the leg massage parts. Such a problem may cause accidents.

Therefore, there is a need for research on a massage device, which has leg massage parts and can prevent accidents.

### DISCLOSURE

### Technical Problem

An object of the present invention is to provide a massage device in which leg massage parts corresponding to both legs operate individually.

Moreover, in order to overcome the problem, the present invention provides a massage device capable of preventing problems, such as accidents caused when a portion of the body of a user or things are caught between the leg massage parts, and troubles/damages of the device.

Furthermore, in order to overcome the problem, the present invention provides a massage device which is easy to assemble the leg massage parts.

The objects of the present invention are not limited to the above-mentioned effects, and other effects, which are not specifically mentioned herein, will be clearly understood by those skilled in the art from the following description.

### Technical Solution

To accomplish the above-mentioned objects, according to the present invention, there is provided a massage device including: a leg connection frame; a first leg massage part connected to the leg connection frame in a rotatable manner and accommodating one leg of a user; a second leg massage part connected to the leg connection frame to be spaced apart from the first leg massage part, provided to be rotated independently from the first leg massage part, and accommodating the other leg of the user; a center support bracket provided on the leg connection frame, rotatably supporting the inner side of the first leg massage part and the inner side of the second leg massage part; and a side support bracket provided on the leg connection frame, rotatably supporting the outer side of the first leg massage part and the outer side of the second leg massage part.

Moreover, the first leg massage part includes a first center bushing rotatably inserted and coupled to the center support bracket and a first side bushing rotatably inserted and coupled to the side support bracket, and the second leg massage part includes a second center bushing rotatably inserted and coupled to the center support bracket and a second side bushing rotatably inserted and coupled to the side support bracket.

Furthermore, the center support bracket includes: a center fixing member connected to the leg connection frame and provided with a center bushing receiving groove; and a center rotating member rotatably provided on the center fixing member and provided with a center bushing fixing groove corresponding to the center bushing receiving groove. The side support bracket includes: a side fixing member connected to the leg connection frame and provided with a side bushing receiving groove; and a side rotating member rotatably provided on the side fixing member and provided with a side bushing fixing groove corresponding to the side bushing receiving groove.

Additionally, the first center bushing and the second center bushing are rotatably arranged within a space formed by the center bushing receiving groove and the center bushing fixing groove, and the first side bushing and the second side bushing are rotatably arranged within a space formed by the side bushing receiving groove and the side bushing fixing groove.

In addition, the center fixing member includes: a base part forming the bottom surface; and side parts bent and protruding from both sides of the base part. Each of the side parts includes: a leg connection frame insertion hole of which one side end facing the leg connection frame is cut to allow the leg connection frame to be inserted; and a center rotating member insertion hole to which the center rotating member is rotatably hinged.

Moreover, the first leg massage part includes: a first leg frame provided with a first shaft housing inside; and a first shaft of which both end portions penetrate the first shaft housing to be exposed to the outside of the first leg frame and are coupled to the first shaft housing, wherein the first center bushing is coupled to one end of the first shaft, and the first side bushing is coupled to the other end of the first shaft. The second leg massage part includes: a second leg frame provided with a second shaft housing inside; and a second shaft of which both end portions penetrate the second shaft housing to be exposed to the outside of the second leg frame and are coupled to the second shaft housing, wherein the second center bushing is coupled to one end of the second shaft, and the second side bushing is coupled to the other end of the second shaft.

Furthermore, on the outer peripheral surface of the first center bushing, a first center support rib for preventing separation of the center support bracket protrudes radially outward, on the outer peripheral surface of the first side bushing, a first side support rib for preventing separation of the side support bracket protrudes radially outward, on the outer peripheral surface of the second center bushing, a second center support rib for preventing separation of the center support bracket protrudes radially outward, and on the outer peripheral surface of the second side bushing, a second side support rib for preventing separation of the side support bracket protrudes radially outward.

Additionally, bearings are coupled on the outer peripheral surfaces of the first center bushing, the first side bushing, the second center bushing, and the second side bushing where the first center support rib, the first side support rib, the second center support rib, and the second side support rib are not formed. The bearings are supported by the center support bracket and the side support bracket.

In addition, the first center bushing, the first side bushing, the second center bushing, and the second side bushing include at least one of Polyacetal and glassfiber.

Moreover, the center rotating member is rotatably hinge-coupled to the center fixing member through a center rotation axis, and the side rotating member is rotatably hinge-coupled to the side fixing member through a side rotation axis. The center rotation axis is integrally provided with the center rotating member or the center fixing member, and the side rotation axis is integrally provided with the side rotating member or the side fixing member.

Furthermore, when external force is applied to the inside of the center support bracket, a safety sensor module is provided which controls the operation of the first leg massage part and the second leg massage part or emits an alarm signal.

### Advantageous Effects

The massage device according to an embodiment of the present invention can provide massage needed for each leg of the user because the leg massage parts operate individually.

Moreover, the massage device according to an embodiment of the present invention can prevent problems, such as accidents caused when a portion of the body of a user or things are caught between the leg massage parts, and troubles/damages of the device.

Furthermore, the massage device according to an embodiment of the present invention can be easy to assemble the leg massage parts.

The effects of the present invention are not limited to the above-mentioned effects, and other effects, which are not specifically mentioned herein, will be clearly understood by those skilled in the art from the following description.

### DESCRIPTION OF DRAWINGS

FIG. 1 is a view for depicting a massage device according to an embodiment of the present invention.

FIG. 2 is a view for depicting a main frame according to an embodiment of the present invention.

FIG. 3 is a view for depicting a detailed configuration of a massage device according to an embodiment of the present invention.

FIG. 4 is a view illustrating an external device that can communicate with a massage device according to an embodiment of the present invention.

FIG. 5 is a view for depicting that leg massage parts individually rotate in a massage device according to an embodiment of the present invention.

FIG. 6 is a view for depicting the rotational principle of the leg massage part in FIG. 5.

FIG. 7 is a view illustrating a state in which the leg massage part is connected to a leg connection frame according to an embodiment of the present invention.

FIG. 8 is a cross-sectional view according to the line A-A′ of FIG. 7.

FIG. 9 is a cross-sectional view according to the line B-B′ of FIG. 7.

FIG. 10A is a view illustrating a state in which a shaft is connected to a center support bracket and a side support bracket according to an embodiment of the present invention, and FIG. 10B is a view illustrating a rotated state of a center rotating member.

FIG. 11 is a schematic plan view of FIG. 10.

FIG. 12A is a cross-sectional view according to the line C-C′ of FIG. 10, and FIG. 12B is a cross-sectional view according to the line C-C′ of FIG. 10 according to another embodiment of the present invention.

FIG. 13A is a view illustrating a center support bracket according to another embodiment of the present invention, and FIG. 13B is a view illustrating a center support bracket according to yet another embodiment of the present invention.

(a) and (b) of FIG. 14 are views illustrating a process of fastening a center bushing to the center support bracket, and (c) and (d) of FIG. 14 are views illustrating a process of fastening a side bushing to a side support bracket.

FIG. 15 is an enlarged view of a part D of FIG. 7.

FIG. 16 is a view illustrating a disassembled state of a safety sensor module according to an embodiment of the present invention.

FIG. 17 is a view illustrating another example of the safety sensor module according to an embodiment of the present invention.

FIG. 18 shows views illustrating an operation process of the safety sensor module according to an embodiment of the present invention.

### BEST MODE

There is a massage device including: a leg connection frame; a first leg massage part connected to the leg connection frame in a rotatable manner and accommodating one leg of a user; a second leg massage part connected to the leg connection frame to be spaced apart from the first leg massage part, provided to be rotated independently from the first leg massage part, and accommodating the other leg of the user; a center support bracket provided on the leg connection frame, rotatably supporting the inner side of the first leg massage part and the inner side of the second leg massage part; and a side support bracket provided on the leg connection frame, rotatably supporting the outer side of the first leg massage part and the outer side of the second leg massage part.

### Mode for Invention

Advantages and features of the present invention and methods accomplishing the advantages and features will become apparent from the following detailed description of exemplary embodiments with reference to the accompanying drawings. However, the present invention is not limited to exemplary embodiment disclosed herein but will be implemented in various forms. The exemplary embodiments are provided so that the present invention is completely disclosed, and a person of ordinary skilled in the art can fully understand the scope of the present invention.

Terms used herein will be briefly described, and the disclosed embodiments will be described in detail.

The terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

The singular forms of the components may be understood into the plural forms unless otherwise specifically stated in the context. Furthermore, the plural forms may include singular forms unless otherwise specifically stated in the context.

In the entire specification of the present invention, when a certain part “includes” a certain component, other components are not excluded unless explicitly described otherwise, and other components may in fact be included.

The term, “unit”, used in the present invention means a software element or a hardware element, and the “unit” performs some roles. However, the term, “unit”, is not limited to software or hardware. The “unit” may be configured in an addressable storage medium or may be configured to play one or more processors. Therefore, as an example, a “unit” includes elements, such as software elements, object-oriented software elements, class elements, and task elements, processes, functions, attributes, procedures, subroutines, segments of program codes, drivers, firmware, microcode, circuits, data, databases, data structures, tables, arrays, and variables. Functions provided within the elements and “units” may be combined with a smaller number of elements and “units” or may be further divided into additional elements and “units”.

According to an embodiment of the present invention, the “unit” may be implemented as a processor and a memory. The term “processor” should be interpreted broadly to encompass a general-purpose processor, a central processing unit (CPU), a microprocessor, a digital signal processor (DSP), a controller, a microcontroller, a state machine, and the like. In some environments, a “processor” may refer to an application specific integrated circuit (ASIC), a programmable logic device (PLD), a field programmable gate array (FPGA), or the like. The term “processor” may refer to a combination of processing devices, such as a combination of a DSP genome and a microprocessor, a combination of a plurality of microprocessors, a combination of one or more microprocessors in combination with a DSP couple core, or a combination of any other such configurations.

The term “memory” should be interpreted broadly to include any electronic component capable of storing electronic information. The term memory may refer to various types of processor-readable media such as random access memory (RAM), read-only memory (ROM), non-volatile random access memory (NVRAM), programmable read-only memory (PROM), erase-programmable read-only memory (EPROM ACL), electrically erasable PROM (EEPROM), flash memory, magnetic or optical data storage, registers, and the like. Memory is referred to as being in electronic communication with the processor if the processor can read information from, and/or write information to, the memory. The memory integrated in the processor is in electronic communication with the processor.

In the present specification, an actuator refers to a configuration capable of providing a driving force. For example, the actuator may include a motor, a linear motor, an electronic motor, a DC motor, an AC motor, a linear actuator, an electric actuator, and the like, but is not limited thereto.

In the present specification, according to an embodiment, a massage device may refer to a massage device including a body massage part and a leg massage part. In addition, according to another embodiment, a body massage part 2100 and a leg massage part 2300 may be provided as separate devices (for example, a body massage device and a leg massage device), and the massage device may refer to a body massage device or a leg massage device.

Hereinafter, embodiments of the present invention will be described in detail with reference to the accompanying drawings so as to be easily carried out by a person skilled in the art to which the present invention pertains. In addition, in order to clearly describe the present invention, portions irrelevant to the description will be omitted.

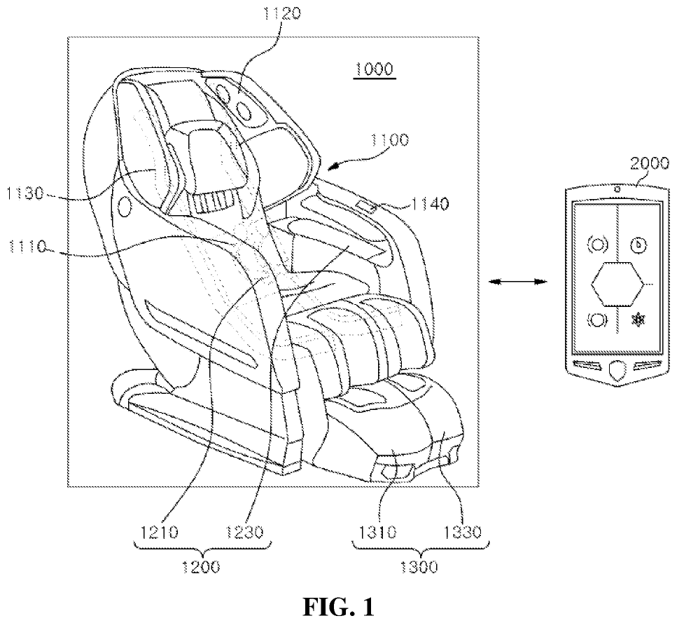

FIG. 1 is a view for depicting a massage device according to an embodiment of the present invention.

The massage device 100 according to an embodiment of the present invention has an area for accommodating at least a portion of the body of a user, supports the user's body (for instance, the torso), and includes a massage part for massaging a portion of the body of the user.

The massage part may include at least one of a body massage part 1100 massaging at least a portion of the body of the user, an arm massage part 1200 massaging the user's arms, and a leg massage part 1300 massaging the user's legs.

The body massage part 1100 can massage at least a portion of the body of the user. For instance, the body massage part 1100 can massage at least a portion of either the user's upper body or lower body.

In detail, the body massage part 1100 may include a massage module 1110, which provides a massage function to at least a portion of the body of the user, an audio output module 1120, which provides any type of audio output to the user, a main frame 1130 which forms the framework of the body massage part 1100 and supports the user's body, and a user input unit 1140 which receives any type of input from the user.

The components included in the body massage part 1100 are just exemplary embodiments, and the body massage part 1100 may include other various components.

Additionally, the shape and the structure of the massage device 1000 illustrated in FIG. 1 are just examples, and various forms of massage device 1000 can be included within the scope of the present invention without departing from the scope of the present invention defined by the claims of the present invention.

The body massage part 1100 can form a space of any shape to accommodate the user. The body massage part 1100 may have a space with the shape corresponding to the shape of the body of the user. For example, as illustrated in FIG. 1, the body massage part 1100 can be realized as a seat type that can accommodate the user's whole body or a portion of the body and can support at least a portion of the body of the user. For example, the body massage part 1100 may include a backrest supporting at least a portion of the user's upper body, and a seat supporting at least a portion of the user's lower body.

A portion of the body massage part 1100 which contacts the ground may include any

material or component (for example, a non-slip pad) for increasing frictional force, and may include wheels for enhancing mobility of the massage device 1000.

At least a portion of the body massage part 1100 can slide. For instance, when the body massage part 1100 starts a massage (or when the body massage part 1100 is activated), at least a portion of the body massage part 1100 can slide forward. Additionally, the body massage part 1100 can tilt backwards. As a result, the body massage part 1100 can provide a massage while tilted backwards. For instance, the massage device 1000 may include an actuator that tilts the massage device 1000 or the body massage part 1100 in the backward direction of the massage device 1000 or the body massage part 1100. The massage device 1000 can activate the actuator to tilt the body massage part 1100 or restore the body massage part 1100 to the original state. In this instance, the actuator can be placed in at least a portion of the massage device (for example, the base frame).

According to an embodiment of the present invention, the massage device 1000 may include at least one air cell (not illustrated). The air cell can be located in at least one area of the body massage part 1100 (for instance, at least one of an area corresponding to the user's shoulder, an area corresponding to the pelvis, an area corresponding to the waist, out of the entire area of the body massage part 1100), at least an area of the arm massage part 1200, and at least an area of the leg massage part 1300, but is not limited thereto, and may be placed in various parts of the massage device 1000.

The massage device 1000 may include an air supply unit, which can inflate the air cell by supplying air to the air cell. The air supply unit may be located inside the body massage part 1100 or may be located in the leg massage part 1300. In addition, the air supply unit can be located outside the massage device 1000.

The massage module 1110 may be installed inside the body massage part 1100 to provide any type of mechanical stimulation to a user accommodated in the body massage part 1100. As illustrated in FIG. 1, the massage module 1110 can move along the main frame 1130 installed inside the body massage part 1100. The massage module 1110 can massage at least a portion of the body of the user while moving along the main frame 1130.

A rack gear 1131a may be provided on the main frame 1130 of the body massage part 1100, and the massage module 1110 can provide mechanical stimulation to various parts of the body of the user by moving along the rack gear. For example, the massage module 1110 can massage the user's back, shoulders, waist, buttocks, thighs, or at least one of such body parts by tapping or kneading. The massage module 1110 may include at least one massage part among a ball massage part and a roller massage part, but is not limited thereto.

The main frame 1130 can form a frame of the internal configuration of the body massage part 1100, and may be made of metal or plastic. For example, the main frame 1130 may be made of iron, alloy, steel, etc., but is not limited thereto, and can be realized with various hard materials.

The audio output module 1120 may be provided in various locations. For example, the audio output module 1120 may include multiple output units such as a top audio output unit placed on the top of the seat part in contact with the user, a front audio output unit coupled to the front end of the arm massage part 1200 on both sides of the seat part, and/or a rear audio output unit coupled to the rear end of the arm massage part 1200, but is not limited thereto. In this case, the audio output module 1120 can provide stereophonic sound such as 5.1 channels, but is not limited thereto.

The arm massage part 1200 can be placed at least on one side of the body massage part

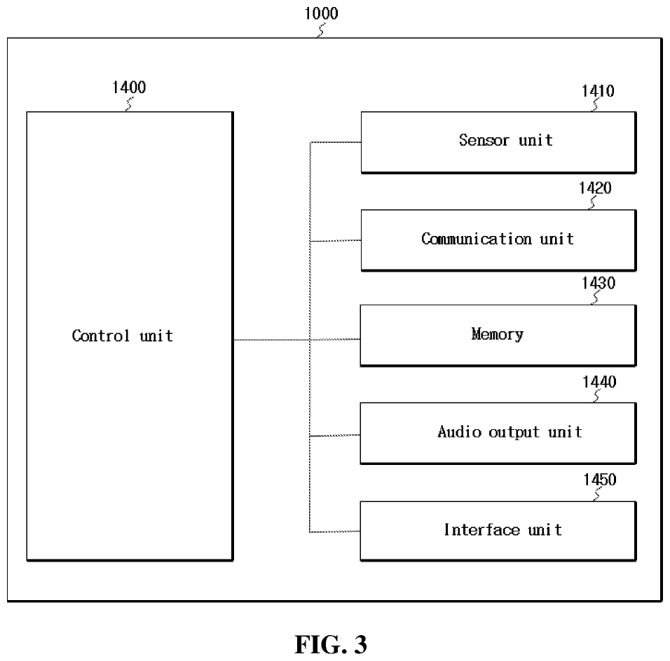

1100. For example, the arm massage part 1200 may include at least one between a first arm massage part 1210 placed on one side of the body massage part 1100 to massage a user's one arm, and a second arm massage part 1230 placed on the other side of the body massage part 1100 to massage the user's other arm. The first arm massage part 1210 can be placed on at least one side of the seat part and the backrest part of the body massage part 1100. The second arm massage part 1230 can be placed on the other side of at least one of the seat part and the backrest part of the body massage part 1100. The first and second arm massage parts 1210 and 1230 can operate independently based on the control of a control unit 1400 (refer to FIG. 3) which controls the massage device 1000.

The leg massage part 1300 can be placed at the bottom of the body massage part 1100 and/or at the front bottom of the massage device 1000. The leg massage part 1300 may include at least one of a first leg massage part 1310 placed on one side of the leg massage part 1300 to massage the user's one leg, and a second leg massage part 1330 placed on the other side of the leg massage part 1300 to massage the user's other leg.

The leg massage part 1300 includes a receiving space for accommodating the user's leg, and can provide a leg massage to the user by massaging at least a portion of the user's leg. For example, the leg massage part 1300 may include a calf massage part which massages the user's calf and/or a foot massage part which massages the user's foot.

The leg massage part 1300 can be adjustable in length according to the user's body characteristics. For example, when a user who is tall uses the massage device 1000, it is necessary to extend the length of the leg massage part 1300 since the user's calves are long. Moreover, when a user who is short uses the massage device 1000, it is necessary to reduce the length of the leg massage part 1300 since the user's calves are short. Accordingly, the leg massage part 1300 can provide a leg massage tailored to the user's height. According to an embodiment of the present invention, the user can control the massage device 1000 using a massage device control device 2000. The massage device control device 2000 can be connected to the massage device 1000 through wired communication and/or wireless communication.

The massage device control device 2000 may include at least one user device (personal device), such as a remote controller, a cellular phone, and a PDA (Personal Digital Assistant), but is not limited thereto, and may include various electronic devices that can be connected to the massage device 1000 through wired or wireless communication.

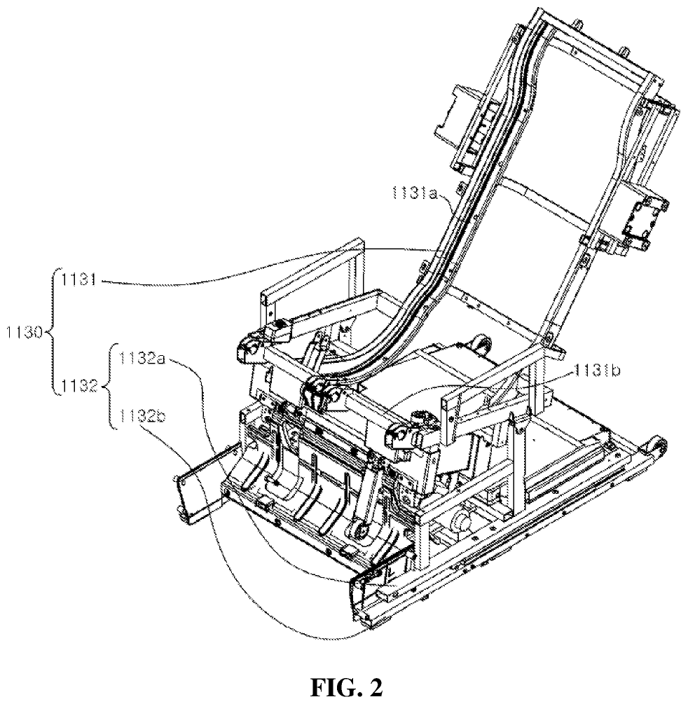

FIG. 2 is a view for depicting a massage device according to an embodiment of the present invention.

According to an embodiment of the present invention, the main frame 1130 may include an upper frame 1131, on which a massage module 1110 is equipped, and a base frame 1132 that supports the upper frame 1131.

A rack gear 1131a may be provided on at least a portion of the upper frame 1131. The rack gear 1131a may include a plurality of teeth and a plurality of valleys, as a member guiding the vertical movement of the massage module 1110.

According to an embodiment of the present invention, the rack gears 1131a may be provided on both sides of the upper frame 1131 to face each other, and the massage module 1110 may move along the rack gear 1131a.

In FIG. 2, the rack gears 1131a are formed in the vertical direction, but are not limited thereto. The rack gear 1131a may include a front-rear direction rack gear and a vertical rack gear. The front-rear direction in the present invention means the direction heading towards the user from the massage module 100 or heading towards the massage module 100 from the user, and may means the X-axis direction based on FIG. 2.

The massage module 1110 may include a gear that meshes with the rack gear 1131a. More specifically, the massage module 1110 may include gears that respectively mesh with a front-rear direction rack gear and a vertical rack gear. By the rotation of the gear by an actuator equipped on the massage module 1110, the massage module 1110 can move forward, backward, upward, or downward.

As the massage module 1110 moves forward, the intensity of the massage may increase. Additionally, as the massage module 1110 moves backward, the intensity of the massage may decrease.

The rack gear 1131a may be made of metal or plastic materials. For example, the rack gear 1131a may be made of iron, steel, alloy, reinforced plastic, melamine resin, phenolic resin, etc., but is not limited thereto.

The upper frame 1131 may be realized in various shapes. For instance, the upper frame 1131 may be classified into an S-frame, an L-frame, an S&L frame, a double S&L frame according to shapes, but is not limited thereto.

The S-frame refers to a frame where at least a portion of the upper frame 1131 includes a curved shape like “S”. The L-frame means a frame that includes a bent shape like “L” in at least a portion of the upper frame 1131. The S&L frame means a frame including an “S”-shaped curved form and an “L”-shaped bent form. The double S&L frame means a frame including an “L”-shaped bent form and two “S”-shaped curved forms.

The base frame 1132 means a part which supports the upper frame 1131 and contacts the ground or the installation surface of the massage device 1000. The base frame 1132 may include an upper base frame 1132a and a lower base frame 1132b.

The upper base frame 1132a may support the upper frame 1131, and the lower base frame 1132b may come into contact with the ground or the installation surface of the massage device 1000. Additionally, the upper base frame 1132a can be positioned to contact the lower base frame 1132b.

According to an embodiment of the present invention, the upper base frame 1132a can move along the lower base frame 1132b. For instance, the upper base frame 1132a can slide forwards or backwards along the lower base frame 1132b. In this case, the upper frame 1131 is connected to the upper base frame 1132a, can move according to the movement of the upper base frame 1132a.

For example, when the upper base frame 1132a moves forward, the upper frame 1131 can also move forward, and when the upper base frame 1132a moves backward, the upper frame 1131 can also move backward. As a result, the sliding movement of the body massage part 1100 can be permitted.

To allow the movement of the upper base frame 1132a, a moving wheel may be provided on the underside of the upper base frame 1132a. Additionally, a guide member, which can guide the moving wheel, may be provided on the top of the lower base frame 1132b. The moving wheel provided on the upper base frame 1132a can move along the guide member provided on the lower base frame 1132b, allowing for the forward or backward movement of the upper base frame 1132a.

According to another embodiment of the present invention, the massage device 1000 may not provide a sliding function, and in this case, the base frame 1132 may not be separated into upper and lower frames.

FIG. 3 is a view for depicting a detailed configuration of a massage device according to an embodiment of the present invention.

According to an embodiment of the present invention, the massage device 1000 may include at least one among a control part 1400, a sensor part 1410, a communication part 1420, memory 1430, an audio output part 1440, and an interface part 1450. The control part 1400 may include at least one processor and memory. The at least one processor can execute instructions stored in memory.

The control part 1400 can control the massage device 1000. For example, the control part 1400 can control at least one among the body massage part 1100, the arm massage part 1200, the leg massage part 1300, the sensor part 1410, the communication part 1420, the memory 1430, the audio output part 1440, the interface part 1450, and the output part. Moreover, the control part 1400 can control various detailed configurations necessary for the operation of the massage device 1000, which are not mentioned above.

The control part 1400 may include one processor, or a plurality of processors. When the control part 1400 includes the plurality of processors, at least some of the plurality of processors can be located at physically distanced locations. In addition, the massage device 1000 is not limited thereto, and can be realized in various ways.

According to an embodiment of the present invention, the control unit 1400 may control the operation of the massage device 1000. For instance, the massage device 1000 may include a plurality of actuators, and the control unit 1400 can control the operation of the massage device 1000 by controlling the operation of the plurality of actuators.

For example, the massage device 1000 may include at least one among a driving unit that moves the armrest frame support, at least one actuator included in the massage module 100, a back angle actuator, a leg angle actuator, a foot massage actuator, a leg length adjustment actuator, and a sliding actuator.

The back angle actuator is an actuator that adjusts the angle of a part of the massage device 1000 contacting with the user's back, and the back angle of the massage device 1000 can be adjusted by the operation of the back angle actuator. The leg angle actuator is an actuator to adjust the angle of the leg massage part 1300 of the massage device 1000, and the angle between the leg massage part 1300 and the body massage part 1100 can be adjusted by the operation of the leg angle actuator. The foot massage actuator represents an actuator that operates the foot massage module included in the leg massage part 1300. For instance, the control unit 1400 can provide a foot massage to the user using the foot massage actuator. The leg length adjustment actuator represents an actuator that adjusts the length of the leg massage part 1300. For example, the control unit 1400 can adjust the length of the leg massage part 1300 to fit the user using the leg length adjustment actuator, and as a result, the user can receive a massage suited to the body shape.

At least one actuator included in the massage module 1110 may be an actuator of various kinds such as a moving actuator, a forward-backward actuator, and a massage actuator.

The moving actuator is an actuator that enables the up and down movement of the massage module 1110, which can move the massage module 1110 in at least one of the upward direction and the downward direction of the massage device 1000 along the main frame 1130. The massage module 1110 can move along the rack gear due to the operation of the moving actuator. The forward-backward actuator can advance (or tilt) the massage module 1110 in at least one of the forward and backward directions. The massage module 1110 can tilt in at least one of the forward and backward directions through the forward-backward actuator. The massage actuator can move the massage module 1110 in various ways to provide various massage actions to the user.

The control unit 1400 can control the operation of the massage device 1000 by controlling the detailed configuration of the massage device 1000.

The control unit 1400 can provide various massage actions by operating at least one actuator included in the massage device 1000. For example, by operating at least one actuator included in the massage module 1110, the control unit 1400 can provide a tapping massage, a kneading massage, and so on, and is not limited to providing various massage actions.

The memory 1430 may be included in the control unit 1400 or can be located outside the control unit 1400. The memory 1430 can store various pieces of information related to the massage device 1000. For instance, the memory 1430 can include massage control information, user information, and is not limited thereto. User information may contain various kinds of information associated with the user, such as personal authentication information, the user's biometric information (for example, age, height, weight, blood pressure, body composition, pulse, electrocardiogram, etc.) and the like.

The memory 1430 can be realized through a non-volatile storage medium, which can continuously store arbitrary data. For example, the memory 1430 may include storage devices based on a disk, an optical disk, a magneto-optical storage device, a flash memory and/or a battery-backed memory, and is not limited thereto.

The memory 1430 is a primary storage device directly accessed by the processor, such as a random access memory (RAM) like a dynamic random access memory (DRAM) and a static random access memory (SRAM), and means a volatile storage device in which stored information is instantly erased when power is turned off, but it is not limited thereto. The memory 1430 can be operated by the control unit 1400.

The massage device 1000 may include a sensor unit 1410. The sensor unit 1410 can acquire various information using at least one sensor. The sensor unit 1410 can be equipped with sensors using measurement means such as pressure, potential, and optics. For example, the sensor unit may include a pressure sensor, an infrared sensor, an LED sensor, a touch sensor, an electrode sensor, an air pressure measurement sensor, and is not limited thereto.

The sensor unit 1410 may include a biometric information acquisition sensor. The biometric information acquisition sensor can acquire at least one of fingerprint information, face information, voice information, iris information, weight information, blood pressure information, heartbeat (or heart rate) information, electrocardiogram information, body composition information, and is not limited to various biometric information. The massage device 1000 can provide a customized massage based on the information acquired through the sensors.

The massage device 1000 can detect a contact area and/or contact position with the user through the sensors. Moreover, the massage device 1000 can provide a customized massage based on the information acquired through the sensors. The sensor unit 1410 may include a safety sensor module 1500. The safety sensor module 1500 can control the operation of the leg massage part 1300 or issue a warning to the user when pressed by the user's body or by other objects. A detailed description of the safety sensor module 1500 will be discussed later.

The communication unit 1420 can receive a signal transmitted from an external device or transmit a signal about the massage device 1000 to the external device.

For example, the control unit 1400 can process the signal received through the communication unit 1420 to acquire a result signal, and can transmit the result signal to the communication unit 1420. The communication unit 1420 can transmit (or output) the result signal to the external device.

The control unit 1400 can acquire information on various components included in the massage device 1000 (for instance, information on the massage module 1110, information on the arm massage part 1200, etc.), and can transmit the information to the communication unit 1420. The communication unit 1420 can transmit the information regarding the massage device 1000 to the external device.

The communication unit 1420 can communicate with an internal module of the massage device 1000, an external massage device and/or a user terminal via any type of network. The communication unit can include a wired/wireless connection module for network access. For wireless connection technology, for example, there are WLAN (Wireless LAN) (Wi-Fi), Wibro (Wireless broadband), Wimax (World Interoperability for Microwave Access), HSDPA (High-Speed Downlink Packet Access), and the like. For wired connection technology, for instance, there are XDSL (Digital Subscriber Line), FTTH (Fibers to the home), PLC (Power Line Communication), and the like. In addition, the network connection unit can include a short-range communication module, which allows data transmission and reception with any device/terminal located in close range. For short-range communication technology, there are Bluetooth, RFID (Radio Frequency Identification), IrDA (infrared Data Association), UWB (Ultra-Wideband), ZigBee, and the like, and the communication technologies are not limited thereto.

The massage device 1000 may further include an interface unit 1450.

The interface unit 1450 can be located in at least a portion of the massage device 1000. For example, the interface unit 1450 can be placed on the exterior of the arm massage part 1200.

The interface unit 1450 can include an input unit and/or an output unit. The input unit can receive user input from the user and transmit it to the control unit 1400. The output unit can display information about the massage device 1000. For example, the output unit can display various information such as the processing results of the control unit 1400, operation information of at least one of the body massage part 1100, the arm massage part 1200, and the leg massage part 1300, information on the massage mode being performed.

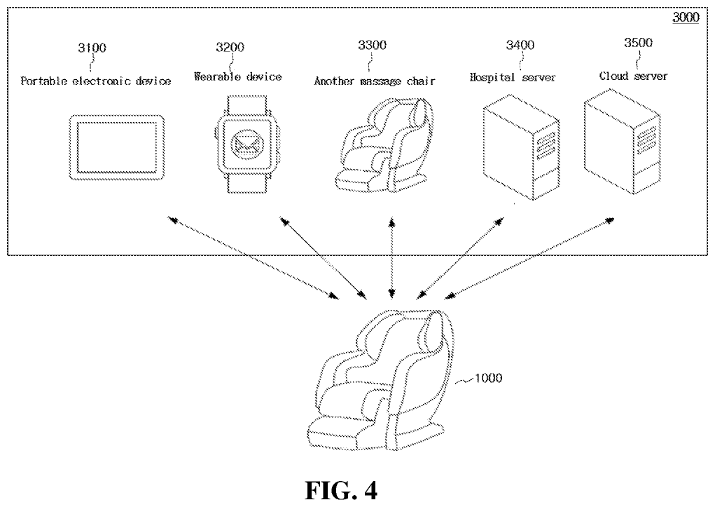

In detail, the input unit can receive commands related to the operation control of the massage device 1000 from the user, and the input unit may be realized in various forms. For example, the input unit can be equipped in the body massage part 1100, and can be equipped in the leg massage part 1300, but is not limited thereto. In addition, the input unit may include a user input unit 1140 of FIG. 1, a massage device control device 2000, or various external devices to be described in FIG. 4.

The massage device 1000 can acquire various commands from the user through the input unit. For example, the massage device 1000 can receive any command for selection of the massage module, selection of massage type, selection of massage intensity, selection of massage time, selection of the massage area, selection related to the position and operation of the body massage part 1100, on-off selection for the power of the massage device 1000, selection regarding the operation of the heat function, selection related to music playback, and more, but it is not limited thereto.

The massage device 1000 can provide an interface for selecting the massage mode through the interface unit 1450. For example, the input unit and/or output unit can include a massage device control device 2000. Various modes of medical massage related to body improvement can be listed through the massage device control device 2000.

The medical massage mode may include at least one among a focus mode, a meditation mode, a recovery mode, a stretching mode, a sleep mode, a vitality mode, a golf mode, a hip up mode, a student mode, a zero gravity mode, and a growth mode.

According to another embodiment of the present invention, the interface unit 1450 can be equipped with buttons in the form of a hot key and/or selection buttons to execute direction selection, cancellation, and input, depending on pre-set user settings or its own pre-set functions.

The interface unit 1450 can be realized as a touchscreen, a keypad, a dome switch, a touch pad (pressure/static), a jog wheel, a jog switch, and others, but is not limited thereto.

Moreover, the interface unit 1450 can acquire commands through the user's speech based on voice recognition technology.

The output unit may include a display for displaying the operating situation of the massage device 1000 or the current status of the user. In this case, the display may include at least one of a liquid crystal display (LCD), a thin film transistor-liquid crystal display (TFT LCD), an organic light emitting diode (OLED), a flexible display, a 3D display, and the like, but is not limited thereto.

The output unit may include an audio output unit 1440. The audio output unit 1440 of FIG. 3 may include the audio output module 1120 of FIG. 1. For example, the audio output module 1120 can be placed in various locations of the massage device 1000. The audio output module 1120 can be placed in the area corresponding to the user's head among the entire areas of the body massage part 1100 of the massage device 1000 as illustrated in FIG. 1. In this case, the area corresponding to the user's head may be an area corresponding to at least one side of the upper two sides of the entire area of the body massage part 1100.

The audio output part 1440 can provide any type of audio output to the user. For example, the audio output part 1440 can provide brain stimulation to the user by outputting music and/or binaural beats optimized for the massage pattern provided by the massage device 1000. The audio output part 1440 can output an acoustic signal received through a network (not illustrated) or stored in an internal/external storage medium (not illustrated). For instance, the audio output part 1440 can output music controlled by the user's terminal through a network connection (e.g., a Bluetooth connection) with the user's terminal. In addition, the audio output part 1440 can output any type of acoustic signal related to the operation of the massage device 1000.

A person of ordinary skill in the technical field to which the present invention belongs would know well that the present invention can be realized by being combined with other program modules and/or by a combination of hardware and software. For example, the present invention can be realized by a computer-readable medium.

A medium accessible by a computer can be any computer-readable medium, and such a computer-readable medium includes volatile and non-volatile media, transitory and non-transitory media, and removable and non-removable media. As an example, without limitation, a computer-readable medium can include a computer-readable storage medium and a computer-readable transmission medium.

The computer-readable storage medium includes volatile and non-volatile, transitory and non-transitory, removable and non-removable media realized by any method or technology for storing information such as computer-readable instructions, data structures, program modules, or other data. The computer-readable storage medium includes RAMs, ROMs, EEPROMs, flash memories or other memory technology, CD-ROMs, digital video disks (DVD) or other optical disk storage devices, magnetic cassettes, magnetic tape, magnetic disk storage devices or other magnetic storage devices, or any other medium that can be accessed by a computer and used to store desired information, but is not limited thereto.

FIG. 4 is a view illustrating an external device that can communicate with a massage device according to an embodiment of the present invention.

The massage device 1000 can transmit and receive various data through the communication part 1420 by wire or wirelessly with the external device 3000.

The external device 3000 may include a portable electronic device 3100 such as an AI speaker, a tablet, or a smartphone. The portable electronic device 3100 may be dedicated to the massage device 1000 or may be a general-purpose portable electronic device. In addition, the external device 3000 may include a wearable device 3200 such as a smartwatch or a smart band. The external device 3000 may include another massage device 3300 that the user is not currently using. The external device 3000 may include a hospital server 3400. The external device 3000 may include a personal health record (PHR) server. Additionally, the external device 3000 may include a cloud server 3500. The external device 3000 may include a medical measurement device such as an electronic scale, a blood glucose meter, or a blood pressure meter.

In this invention, examples of the external device 3000 have been described, but any device that can communicate with the massage device 1000 wirelessly or by wire and exchange information may all be regarded as external devices.

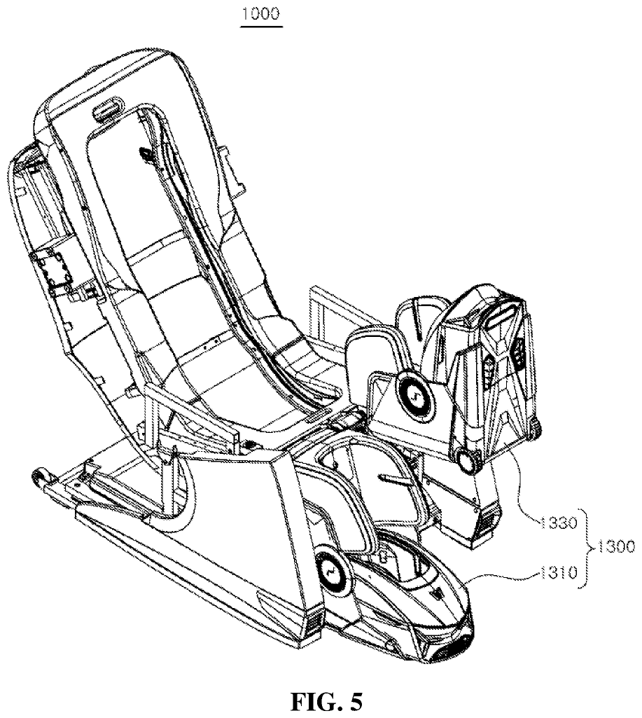

FIG. 5 is a view for depicting that leg massage parts individually rotate in a massage device according to an embodiment of the present invention.

Referring to FIG. 5, the leg massage part 1300 can be provided corresponding to both legs of the user. For example, the leg massage part 1300 may include a first leg massage part 1310 which corresponds to one leg of the user and a second leg massage part 1330 which corresponds to the other leg of the user.

The first leg massage part 1310 and the second leg massage part 1330 can be controlled independently. For example, the first leg massage part 1310 and the second leg massage part 1330 can individually provide a massage function to the user. In addition, the first leg massage part 1310 and the second leg massage part 1330 can rotate independently. The user can receive different massages on both legs as needed, or receive alternating massages on both legs. Furthermore, the user can receive a stretch or a massage caused by rotation on both legs. In this case, the first leg massage part 1310 and the second leg massage part 1330 can rotate both legs of the user at the same time or individually.

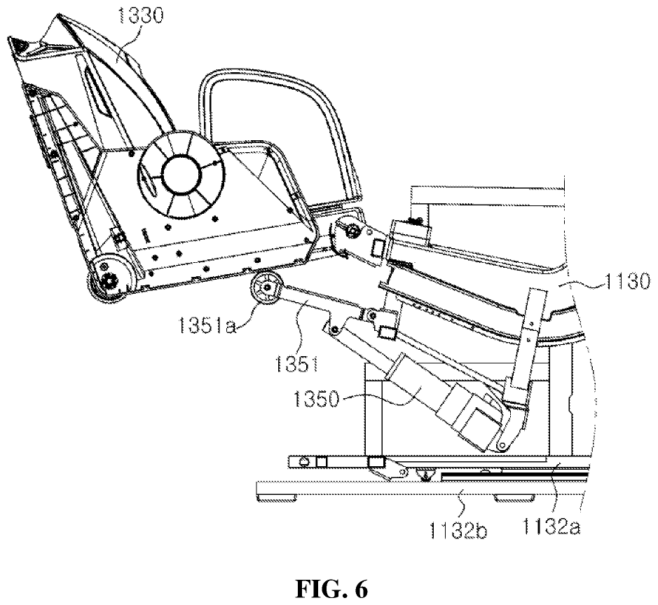

FIG. 6 is a view for depicting the rotation principle of the leg massage part of FIG. 5.

Referring to FIG. 6, the massage device 1000 can include a leg angle actuator 1350 for rotating the leg massage part 1300. The leg angle actuator 1350 can be placed inside the body massage portion 1100. For example, the leg angle actuator can be connected to the main frame 1130.

The leg angle actuator 1350 can be driven to extend in one direction. As the leg angle actuator 1350 extends, the leg massage part 1300 can be rotated. The leg angle actuator 1350 can be provided to correspond to the first leg massage part 1310 and the second leg massage part 1330, respectively. The two leg angle actuators 1350 can be individually connected to the first leg massage part 1310 and the second leg massage part 1330, respectively, and can individually rotate the first leg massage part 1310 and the second leg massage part 1330.

The leg angle actuator 1350 may include a link member 1351 at an end. The link member 1351 can come into contact with the leg massage part 1300 and provide rotational power to the leg massage part 1300. A wheel 1351a can be provided at the end of the leg massage part 1300 of the link member 1351.

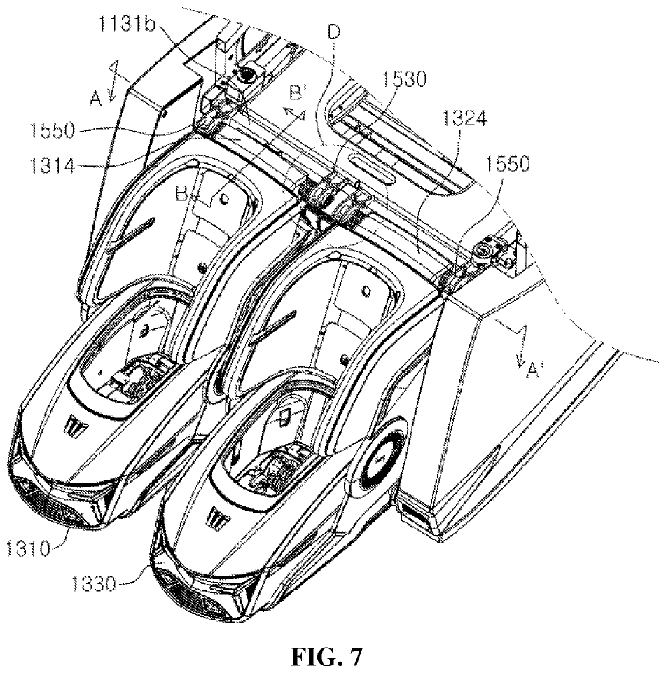

FIG. 7 is a view illustrating a state in which the leg massage part is connected to the leg connection frame according to an embodiment of the present invention.

Referring to FIG. 7, the leg massage part 1300 can be rotatably connected to the leg connection frame 1131b. The upper frame 1131 can include the leg connection frame 1131b. The leg connection frame 1131b can be provided at the front end of the upper frame 1131. The leg connection frame 1131b can be manufactured as a separate component and coupled to the upper frame 1131 or can be integrally manufactured with the upper frame 1131. In the case where the leg connection frame 1131b is integrally manufactured with the upper frame 1131, the leg connection frame 1131b may mean a component of the upper frame 1131.

The leg connection frame 1131b may be connected to a center support bracket 1530 and a side support bracket 1550. For instance, the center support bracket 1530 and the side support brackets 1550 may be welded to the leg connection frame 1131b or can be coupled by fastening components such as bolts or rivets. However, the method of coupling the center support bracket 1530 and the side support brackets 1550 to the leg connection frame 1131b can be replaced with various methods commonly used in the technical field to which the present invention belongs.

The center support bracket 1530 and the side support brackets 1550 can fix the leg massage part 1300 to be rotatable.

The first leg massage part 1310 and the second leg massage part 1330 can be located at the front of the leg connection frame 1131b. For example, the first leg massage part 1310 can be placed on the right side at the front of the leg connection frame 1131b, and the second leg massage part 1330 can be placed on the left side at the front of the leg connection frame 1131b.

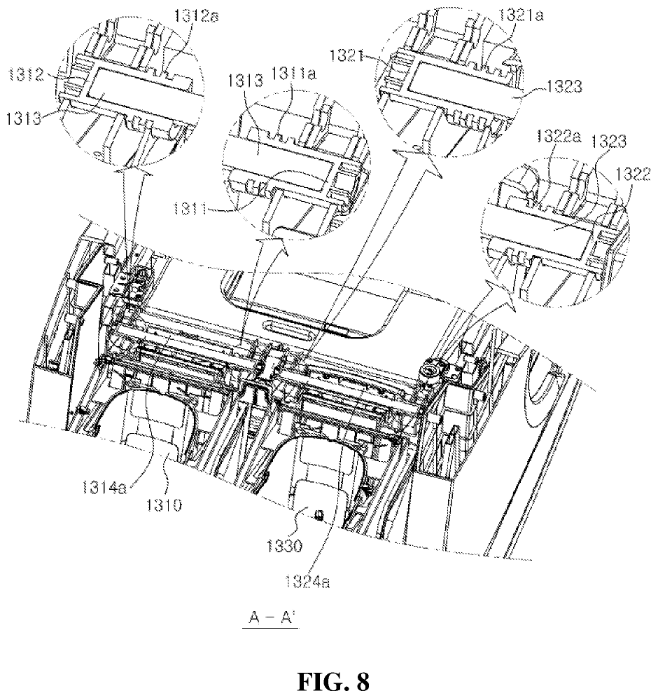

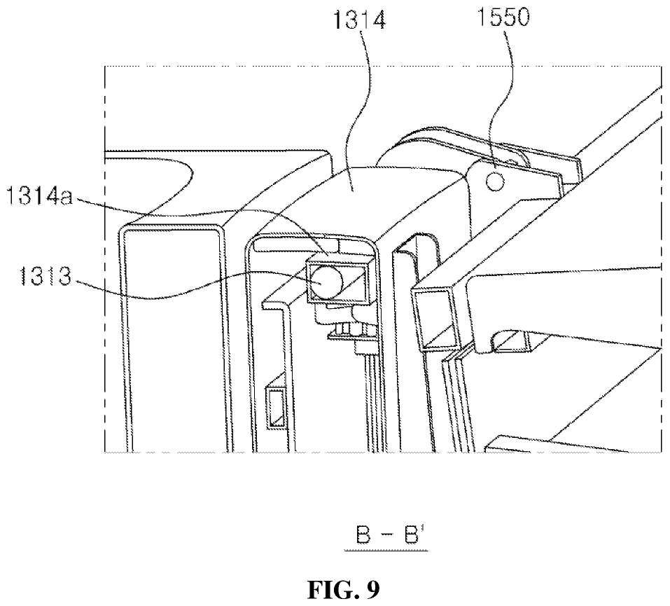

FIG. 8 is a cross-sectional view taken along the line A-A′ of FIG. 7, and FIG. 9 is a cross-sectional view taken along the line B-B′ of FIG. 7.

Referring to FIGS. 8 and 9, the first leg massage part 1310 may include a first center bushing 1311, a first side bushing 1312, a first shaft 1313, and a first leg frame 1314.

The first shaft 1313 can be coupled to the first leg frame 1314 through the first leg frame 1314. For example, a first shaft housing 1314a may be provided inside the first leg frame 1314, and the first shaft 1313 can be coupled by penetrating the first shaft housing 1314a. The first shaft 1313 can be fixed to the first shaft housing 1314a. For instance, the first shaft 1313 can be welded to the first shaft housing 1314a or can be coupled through separate fastening components. The method of coupling the first shaft 1313 to the first shaft housing 1314a is not limited to the described embodiments, and can be replaced with various methods commonly used in the technical field to which the present invention belongs.

Both ends of the first shaft 1313 can be exposed to the outside of the first leg frame 1314. The first center bushing 1311 and the first side bushing 1312 can be coupled to both ends of the first shaft 1313 which are exposed to the outside of the first leg frame 1314.

One end of the first shaft 1313 can be inserted and coupled to the first center bushing 1311, and the other end can be inserted and coupled to the first side bushing 1312.

The first center bushing 1311 and the first side bushing 1312 may include a resin material. For instance, the first center bushing 1311 and the first side bushing 1312 can contain synthetic resin. The synthetic resin, for example, may be polyacetal (POM). The first center bushing 1311 and the first side bushing 1312 can improve wear resistance and fatigue resistance by including the synthetic resin.

Furthermore, the first center bushing 1311 and the first side bushing 1312 can include glass fiber. The first center bushing 1311 and the first side bushing 1312 can enhance corrosion resistance and insulation by including glass fiber.

The first center bushing 1311, the first side bushing 1312, and the first shaft 1313 can also be manufactured in an integrated form. In this case, the first center bushing 1311, the first side bushing 1312, and the first shaft 1313 can be provided with the same material. For instance, the first center bushing 1311, the first side bushing 1312, and the first shaft 1313 can be provided with metal.

The first center bushing 1311 and the first side bushing 1312 can respectively be secured to the center support bracket 1530 and the side support bracket 1550 to be rotatable.

On the outer circumferential surface of the first center bushing 1311, a first center support rib 1311a can be provided to prevent dislocation from the center support bracket 1530. The first center support rib 1311a can protrude radially outward. On the outer circumferential surface of the first center bushing 1311 which does not have the first center support rib 1311a formed, a bearing 1533 can be coupled. The bearing 1533 can be supported by the center support bracket 1530.

On the outer circumferential surface of the first side bushing 1312, a first side support rib 1312a can be provided to prevent dislocation from the side support bracket 1550. The first side support rib 1312a can protrude radially outward. On the outer circumferential surface of the first side bushing 1312 on which the first side support rib 1312a is not formed, a bearing 1533 can be coupled. The bearing 1533 can be supported by the side support bracket 1550.

The second leg massage part 1330 may include a second center bushing 1321, a second side bushing 1322, a second shaft 1323, and a second leg frame 1324. On the outer circumferential surface of the second center bushing 1321, a second center support rib 1321a can be provided, and on the outer circumferential surface on which the second center support rib 1321a is not formed, a bearing 1533 can be coupled. On the outer circumferential surface of the second side bushing 1322, a second side support rib 1322a can be provided, and on the outer circumferential surface on which the second side support rib 1322a is not formed, a bearing 1533 can be coupled.

The above components correspond to the respective components of the first center bushing 1311, the first side bushing 1312, the first shaft 1313, and the first leg frame 1314 of the first leg massage part 1310, and has identical functionality and structure (bilateral symmetry). Therefore, the detailed description of the second leg massage part 1330 is omitted and is replaced by the above description.

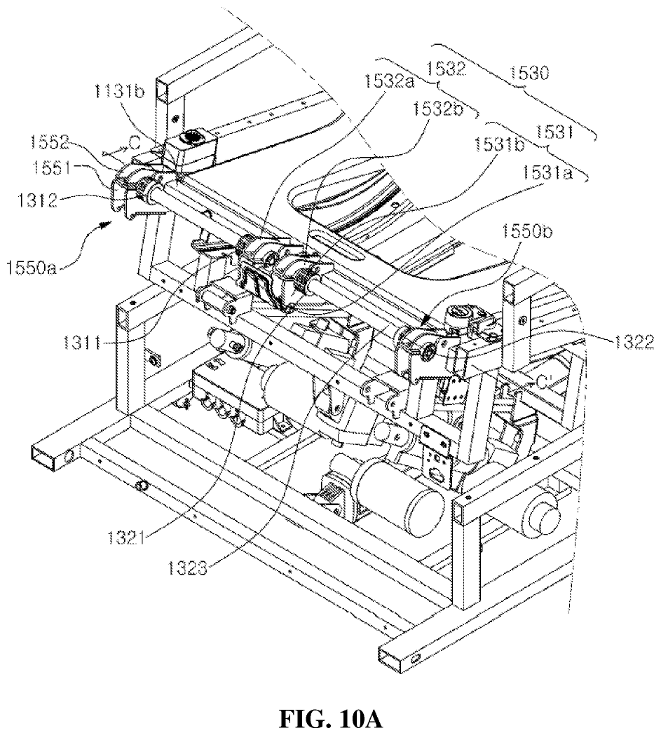

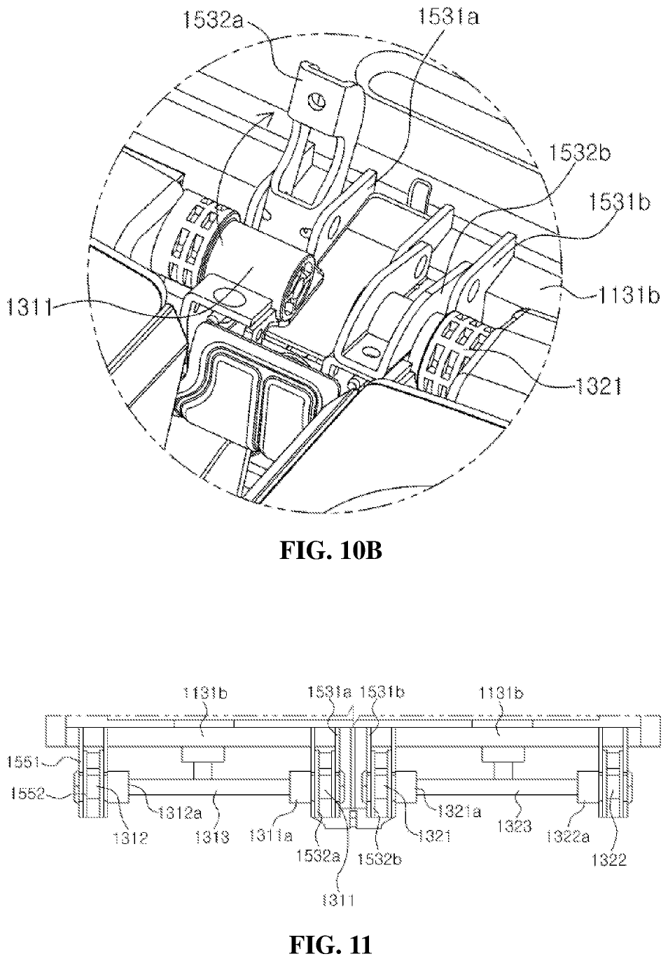

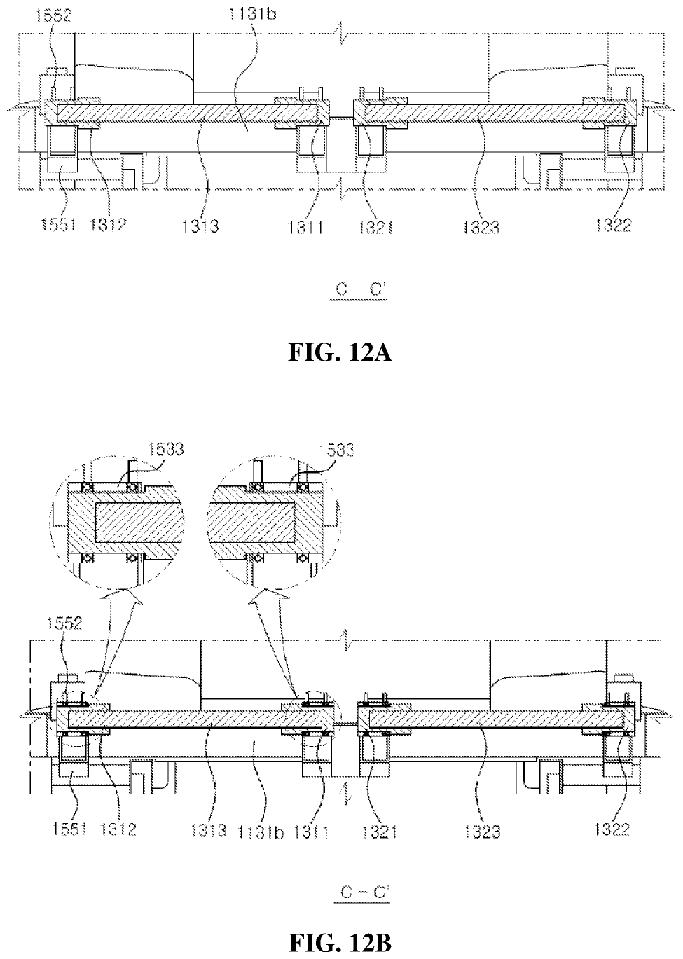

FIG. 10a is a view illustrating a state in which a shaft is connected to a center support bracket and a side support bracket according to an embodiment of the present invention, and FIG. 10b is a view illustrating a rotated state of a center rotating member, FIG. 11 is a schematic plan view of FIG. 10, and FIG. 12a is a cross-sectional view according to the line C-C′ of FIG. 10, and FIG. 12b is a cross-sectional view according to the line C-C′ of FIG. 10 according to another embodiment of the present invention.

Referring to FIGS. 10 to 12, the center support bracket 1530 and the side support bracket 1550 can be coupled to the leg connection frame 1131b.

The center support bracket 1530 can be provided at the center of the leg connection frame 1131b. The center support bracket 1530 can rotatably secure the first center bushing 1311 of the first leg massage part 1310 and the second center bushing 1321 of the second leg massage part 1330.

On the other hand, between the center support bracket 1530 and the center bushings 1311 and 1321, a bearing 1533 (refer to FIG. 12B) can be provided for smooth rotation. The bearing 1533, for instance, can be provided as various bearings used in the technical field to which the present invention pertains, such as a ball bearing, a thrust bearing, a needle bearing, a cylindrical bearing, a spherical roller bearing, etc.

The center support bracket 1530 may include a center fixing member 1531 and a center rotating member 1532.

The center fixing member 1531 can be welded to the leg connection frame 1131b or can be coupled by a separate fastening member. One side of the center rotating member 1532 can be hinged to the center fixing member 1531 to allow rotation. When the center rotating member 1532 rotates so that the end contacts the center fixing member 1531, the rotating member can be bound by a fastening member.

The center fixing member 1531 may include a first center fixing member 1531a and a second center fixing member 1531b. The first center fixing member 1531a and the second center fixing member 1531b can be provided in corresponding shapes.

The center rotating member 1532 may include a first center rotating member 1532a and a second center rotating member 1532b. The first center rotating member 1532a and the second center rotating member 1532b can be provided in corresponding shapes.

The first center rotating member 1532a and the second center rotating member 1532b can each be rotatably coupled to the first center fixing member 1531a and the second center fixing member 1531b, respectively.

The first center fixing member 1531a and the first center rotating member 1532a can rotatably secure the first center bushing 1311. The second center fixing member 1531b and the second center rotating member 1532b can rotatably secure the second center bushing 1321.

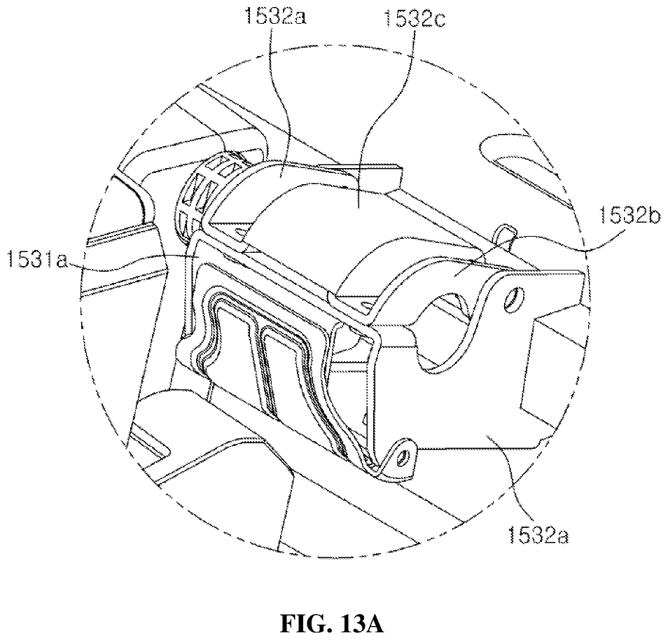

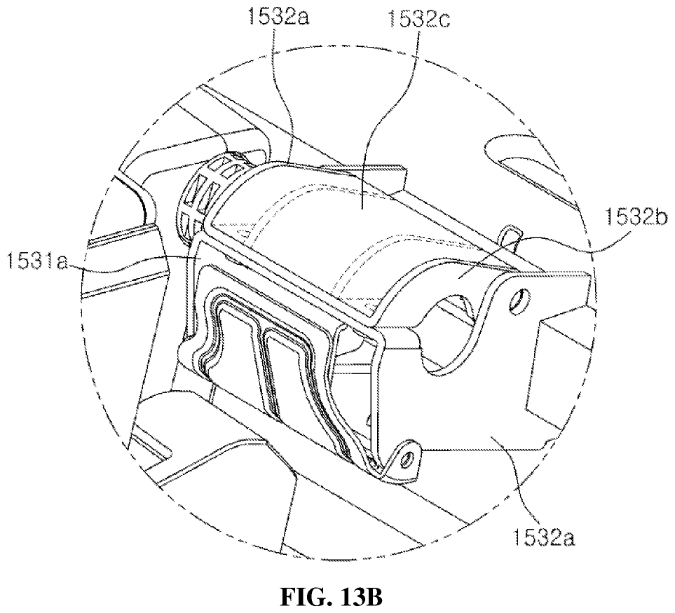

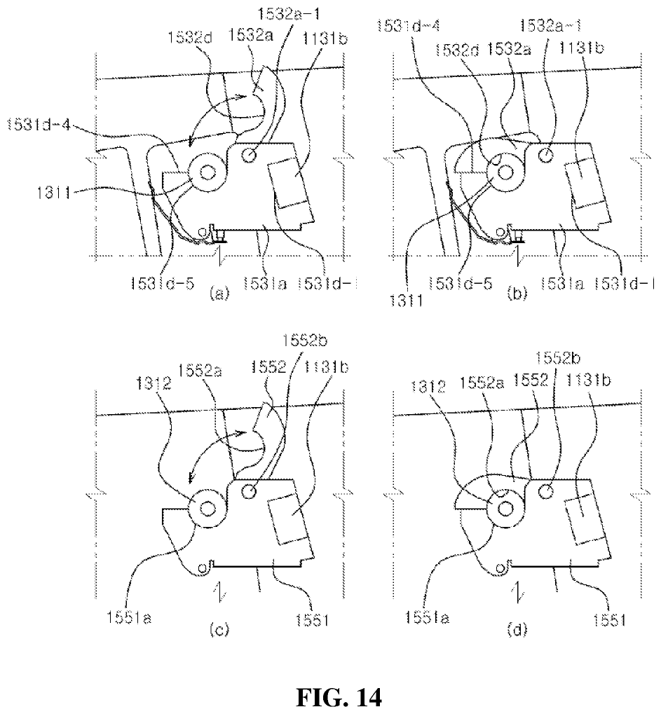

FIG. 13a is a view illustrating a center support bracket according to another embodiment of the present invention, and FIG. 13b is a view illustrating a center support bracket according to yet another embodiment of the present invention.

Referring to FIG. 13a, the first center rotating member 1532a and the second center rotating member 1532b can be connected by a center rotating member cover 1532c. For example, one side of the center rotating member cover 1532c can be connected to the inside of the first center rotating member 1532a, and the other side can be connected to the inside of the second center rotating member 1532b. The center rotating member cover 1532c can be welded to the first center rotating member 1532a and the second center rotating member 1532b, or can be connected through a separate fastening member. However, it is also possible to provide the first center rotating member 1532a, the second center rotating member 1532b, and the center rotating member cover 1532c as one piece. In other words, a single member can be bent and cut multiple times to provide the first center rotating member 1532a, the second center rotating member 1532b, and the center rotating member cover 1532c as one piece.

Referring to FIG. 13b, the center rotating member cover 1532c can be connected to the outside of the first center rotating member 1532a and the second center rotating member 1532b. The center rotating member cover 1532c can be welded to the first center rotating member 1532a and the second center rotating member 1532b, or can be connected through a separate fastening member. In this case, the center rotating member 1532c can be provided to generally cover the upper portion of the first center rotating member 1532a and the second center rotating member 1532b.

Furthermore, it is also possible to connect the center rotating member cover 1532c to the first center rotating member 1532a and the second center rotating member 1532b by means of a mechanical configuration, such as a slide coupling or a hook coupling. As long as the center rotating member cover 1532c is designed to cover at least a portion of the upper part of the first center rotating member 1532a and the second center rotating member 1532b, the configuration which couples the center rotating member cover 1532c can be replaced with various methods commonly used in the technical field to which the present invention belongs.

The center support bracket 1530 may correspond to one component of the safety sensor module 1500 which will be described later. The detailed configuration of the center support bracket 1530 will be described in detail later.

The side support brackets 1550 can be provided on both sides of the leg connection frame 1131b. The side support bracket 1550 can include a first side support bracket 1550a which is provided on the right end of the leg connection frame 1131b and a second side support bracket 1550b which is provided on the left end. The first side support bracket 1550a and the second side support bracket 1550b can be provided in corresponding shapes.

The first side support bracket 1550a can rotatably secure the first side bushing 1312. The second side support bracket 1550b can rotatably secure the second side bushing 1322. Between the side support bracket 1550 and the side bushing 1312 and 1322, a bearing can be provided for smooth rotation.

The side support bracket 1550 can include, for example, a side fixing member 1551 and a side rotating member 1552.

The side fixing member 1551 can be welded to the leg connection frame 1131b or coupled by a separate fastening member. One side of the side rotating member 1552 can be rotatably coupled to the side fixing member 1551. The side rotating member 1552 can rotate to be bound by a fastening member when an end portion comes into contact with the side fixing member 1551.

FIGS. 14a and 14b are views illustrating a process of fastening a center bushing to the center support bracket, and FIGS. 14c and 14d are views illustrating a process of fastening a side bushing to a side support bracket.

Referring to FIGS. 14a and 14b, a process of fastening the first center bushing 1311 to the center support bracket 1530 is described.

The first center fixing member 1531a can be coupled to the leg connection frame 1131b. For example, the first center fixing member 1531a can be welded to the leg connection frame 1131b or coupled through a separate coupling member in a state in which the leg connection frame 1131b is inserted into a leg connection frame insertion hole 1531d-1 formed at one side of the first center fixing member 1531a.

When the first center fixing member 1531a is combined with the leg connection frame 1131b, the first center rotation member 1532a can be rotated upwards. For example, the first center rotation member 1532a can be hinge-coupled to the first center fixing member 1531a through a center rotation axis 1532a-1, and can be rotated upwards based on the center rotation axis 1532a-1. Here, the center rotation axis 1532a-1 may mean a separate rotation axis which connects the first center fixing member 1531a and the first center rotation member 1532a to enable rotation. However, it is also possible to provide the center rotation axis 1532a-1 integrally on any one of the first center fixing member 1531a or the first center rotation member 1532a.

The first center bushing 1311 can be seated in a center bushing receiving groove 1531d-5 of the first center fixing member 1531a.

When the first center bushing 1311 is seated, the first center rotation member 1532a can be rotated downwards. At this time, at least a portion of the upper outer periphery of the first center bushing 1311 can be accommodated in a center bushing fixing groove 1532d of the first center rotation member 1532a. the center bushing housing hole 1531d-5 and the center bushing fixing hole 1532d can support the first center bushing 1311 to enable rotation.

When the first center rotation member 1532a is rotated downward and the end contacts a fixed piece 1531d-4 of the first center fixing member, the first center rotation member 1532a can be bound to the fixed piece 1531d-4 by the fastening member.

A process of the second center bushing 1321 being fastened to the center support bracket 1530 is the same as the previously mentioned process of the first center bushing 1311 being fastened to the center support bracket 1530.

Referring to FIGS. 14b and 14c, a process of the first side bushing 1312 being fastened to the first side support bracket 1550a will be described.

The side fixing member 1551 can be combined with the leg connection frame 1131b. For example, the side fixing member 1551 can be welded to the leg connection frame 1131b or can be combined through a separate fastening member.

When the side fixing member 1551 is combined with the leg connection frame 1131b, the side rotation member 1552 can be rotated upwards. For example, the side rotation member 1552 can be hinge-coupled to the side fixing member 1551 through a side rotation axis 1552b, and can be rotated upwards based on the side rotation axis 1552b. Here, the side rotation axis 1552b may mean a separate rotation axis which connects the side fixing member 1551 and the side rotation member 1552 to enable rotation. However, it is also possible to provide the side rotation axis 1552b integrally on any one of the side fixing member 1551 or the side rotation member 1552.

The first side bushing 1312 can be lodged in the side bushing receptacle 1551a of the side fixing member 1551.

When the first side bushing 1312 is placed, the side rotating member 1552 can be rotated downward. At this time, at least a portion of the upper outer circumferential surface of the first side bushing 1312 can be accommodated in a side bushing fixing hole 1552a of the side rotating member 1552. The side bushing receptacle 1551a and the side bushing fixing hole 1552a can support the first side bushing 1312 to allow rotation.

When the side rotating member 1552 rotates downward and comes into contact with the side fixing member 1551, the side rotating member 1552 can be bound to the side fixing member 1551 by a fastening member.

A process of securing the second side bushing 1322 to the second side support bracket 1550b is the same as the process of securing the first side bushing 1312 to the first side support bracket 1550a.

As described above, since the center bushing and the side bushing can be fixed by being placed and coupled to the center support bracket 1530 and the side support bracket 1550, respectively, the leg massage part 1300 can be easily connected to the body massage part 1100.

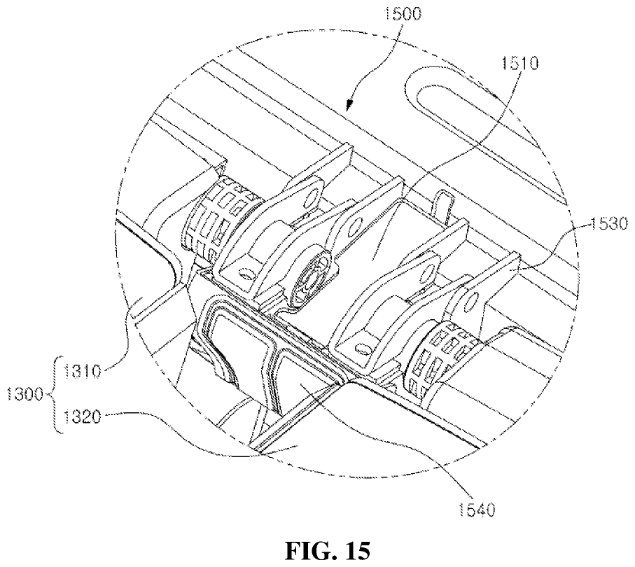

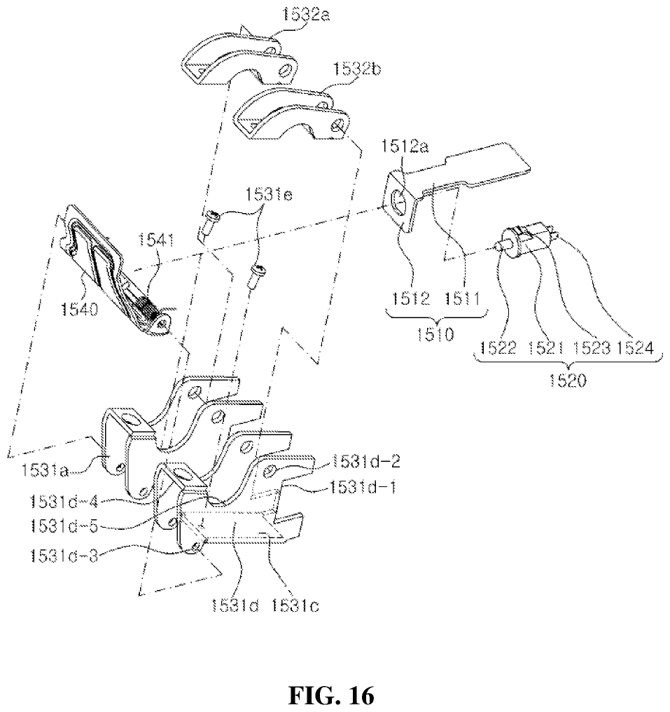

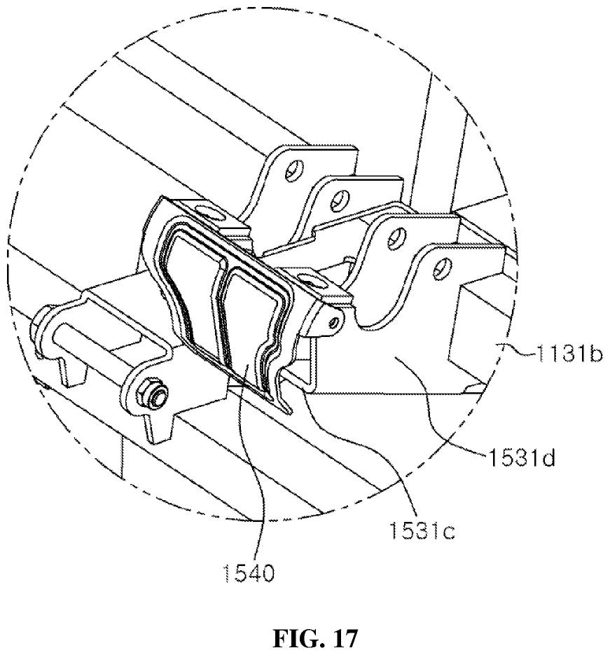

FIG. 15 is an enlarged view of a part D of FIG. 7, FIG. 16 is a view illustrating a disassembled state of a safety sensor module according to an embodiment of the present invention, and FIG. 17 is a view illustrating another example of the safety sensor module according to an embodiment of the present invention.

Referring to FIGS. 15 and 16, a massage device 1000 according to an embodiment of the present invention may include a safety sensor module 1500.

The safety sensor module 1500 can be provided on the leg connection frame 1131b. For example, the safety sensor module 1500 can be provided on a portion of the leg connection frame 1131b which corresponds to a space between the first leg massage part 1310 and the second leg massage part 1330.

The safety sensor module 1500 can control the operation of at least one of the first leg massage part 1310 and the second leg massage part 1330 when an external force is applied. For example, the safety sensor module 1500 can stop the rotation of at least one of the first leg massage part 1310 and the second leg massage part 1330 when an external force is applied. In addition, the safety sensor module 1500 can rotate the first leg massage part 1310 and the second leg massage part 1330 by a certain angle in the direction opposite to the direction in which at least one of the first leg massage part 1310 and the second leg massage part 1330 is rotating when an external force is applied.

The safety sensor module 1500 may include an alarm unit (not illustrated) that emits a warning signal to the user when an external force is applied. The alarm unit may include, for example, at least one of a light emitting lamp, an audio element, and a vibration element. The light emitting lamp can emit light to the user to transmit a warning signal. The audio element may refer to the audio output module 1120 or a separate audio device. The audio can transmit a warning signal to the user through an alert sound. The vibration element may be equipped with a vibration panel, a vibration actuator, and the like. The vibration element can transmit a warning signal to the user by applying vibration to at least one among a body massage part 1100, an arm massage part 1200, and a leg massage part 1300. In this case, the light emitting lamp and/or the vibration element can be arranged in the leg massage part 1300. For example, the light emitting lamp can be positioned at various locations on the appearance (or exterior) of the leg massage part 1300. The vibration element can be placed in an area adjacent to the user's body among the entire area of the leg massage part 1300, such as an area corresponding to the sole of the foot an area corresponding to the calf, and the like.

Therefore, the safety sensor module 1500 can prevent accidents caused by the user's body getting caught between the leg massage parts 1300. Furthermore, the safety sensor module 1500 can prevent device damage or malfunctions caused by the influx of objects between the leg massage parts 1300.

The safety sensor module 1500 may include a sensor bracket 1510, a sensor 1520, a center support bracket 1530, and a pressure plate 1540.

The sensor bracket 1510 can be provided to support the sensor 1520. The sensor bracket 1510 can be coupled to a leg connection frame 1131b. For example, the sensor bracket 1510 can be welded to the leg connection frame 1131b or coupled by a separate fastening device. A method of coupling the sensor bracket 1510 to the leg connection frame 1131b can be replaced with various methods commonly used in the technical field to which the present invention belongs.

The sensor bracket 1510 may include a protrusion part 1511 and a curved part 1512. The protrusion part 1511 has one side which can be coupled to the leg connection frame 1131b and the other side which can protrude forward. The curved part 1512 can be curved downward from the protruding end of the protrusion part 1511. Therefore, the sensor bracket 1510 can be overall in a “L” shape. The curved part 1512 may have a sensor coupling hole 1512a.

The sensor 1520 can be coupled to the sensor bracket 1510. For example, the sensor 1520 can be coupled to the curved part 1512 of the sensor bracket 1510. In this case, at least a portion of the sensor 1520 can be configured to penetrate the sensor coupling hole 1512a of the sensor bracket. Therefore, at least a portion of the sensor 1520 can protrude forward from the curved part 1512.

The sensor 1520 can detect contact with the pressure plate 1540. For example, when an external force is applied to the pressure plate 1540 to rotate the pressure plate 1540, the pressure plate 1540 can come into contact with the sensor 1520. When the sensor 1520 comes into contact with the pressure plate 1540, the sensor 1520 can transmit the corresponding information to the control unit 1400. Upon receiving the information on the contact between the pressure plate 1540 and the sensor 1520, the control unit 1400 can control the operation of at least one of the first leg massage part 1310 and the second leg massage part 1330. Additionally, the control unit 1400 can activate the alarm unit to emit a warning signal to the user.

The sensor 1520 can be equipped with measurement means such as pressure, voltage, and optical sensors. For example, the sensor 1520 may include a sensor housing 1521, a contact portion 1522 that is provided in the sensor housing 1521 to detect contact with the pressure plate 1540, a fastening portion 1523 for coupling to the sensor bracket 1510, and an electrode terminal 1524 for electrical connection to the external device.

The contact portion 1522 can slide inward in the sensor housing 1521 when pressure is applied by the pressure plate 1540. Accordingly, a separate elastic member that applies elastic force to the contact portion 1522 can be provided inside the sensor housing 1521. When the contact portion 1522 receives pressure and slides inward in the sensor housing 1521, the sensor 1520 can transmit a signal to the control unit 1400, so the control unit 1400 can control the operation of at least one of the first leg massage part 1310 and the second leg massage part 1330 or emit a warning signal to the user through the alarm unit.

The fastening portion 1523 can be provided for coupling with the sensor bracket 1510. The fastening portion 1523 can be made of a material with elastic force and can be inserted into the sensor coupling hole 1512a formed in the sensor bracket 1510 when the sensor 1520 is coupled. To facilitate insertion into the sensor coupling hole 1512a, the fastening portion 1523 may include inclined surfaces. The inclined surface can be configured such that the distance between the sensor housing 1521 and the sensor 1520 increases from the rear to the front while one end is fixed to the sensor housing 1521. Additionally, a flat surface can be provided on the other end of the inclined surface to facilitate contact with the sensor coupling hole 1521a. The flat surface can come into contact with the inner side of the sensor coupling hole 1521a. The fastening portion 1523 can be folded towards the sensor housing 1521 when gripped by the user. Therefore, when the sensor 1520 needs to be separated, the user can grip the fastening portion 1523 and detach the sensor 1520 from the sensor bracket 1510.

In the meantime, the sensor 1520 can be replaced with various sensors commonly used in the technical field to which the present invention belongs, which can detect the rotation or contact of the pressure plate 1540. For example, the sensor 1520 can be equipped with at least one of a pressure sensor, an infrared sensor, an LED sensor, a touch sensor, or an electrode sensor.

The center support brackets 1530 may be arranged on both sides of the sensor bracket 1510. The center support bracket 1530 can be made separately from or integrally with the sensor bracket 1510. Alternatively, the center support bracket 1530 and the sensor bracket 1510 can be separately made and then combined using a method such as welding. The method of combining the center support bracket 1530 and the sensor bracket 1510 can be replaced with various methods commonly used in the technical field to which the present invention belongs. The center support bracket 1530 can be connected to the pressure plate 1540 in a rotatable manner. The sensor bracket 1510 may include a center fixing member 1531 and a center rotating member 1532.

The center fixing member 1531 can include, for example, a base part 1531c and side parts 1531d protruding upwards from both sides of the base part 1531c. The base part 1531c and side parts 1531d can be formed by a single member being bent. However, it is also possible to separately manufacture the base part 1531c and the side parts 1531d and combine them together.

The base part 1531c can form the lower surface of the center fixing member 1531. The base part 1531c may include at least one stopper 1531e. The stopper 1531e can restrict an angle at which the pressure plate 1540 rotates in the direction away from the sensor 1520. The stopper 1531e can protrude downward through the base part 1531c. When a single stopper 1531e is provided, the stopper can be positioned in the central area of the base part 1531c, and when multiple stoppers are provided, the stoppers may be arranged in at least one of the central area and both side area of the base part 1531c.

The positions and structures of the stoppers 1531e may be varied to limit the rotational angle of the pressure plate 1540. For example, it is also possible to mount the stopper 1531e to the lower surface of the base part 1531c and cause the entire stopper 1531e to protrude downward from the base part 1531c. Additionally, it is also possible to integrally manufacture the stopper 1531e with the base part 1531c. Furthermore, it is also possible to equip the stopper 1531e on the pressure plate 1540.

The side parts 1531d may include leg connection frame insertion grooves 1531d-1. The leg connection frame 1131b can be inserted and coupled to the leg connection frame insertion grooves 1531d-1. The leg connection frame insertion grooves 1531d-1 can be configured with one end of the side part 1531d facing the leg connection frame 1131b being cut off. The inner side of the leg connection frame insertion grooves 1531d-1 may have a shape matching the outer side of the leg connection frame 1131b. When the leg connection frame 1131b is inserted into the leg connection frame insertion grooves 1531d-1, the contacting portion between the side part 1531d and the leg connection frame 1131b can be welded. However, the method of combining the side part 1531d and the leg connection frame 1131b can be replaced with methods commonly used in the technical field to which the present invention belongs.

The side part 1531d can include a center rotating member insertion hole 1531d-2. The center rotating member 1532 can be hinge-coupled and rotatably coupled to the center rotating member insertion hole 1531d-2. The center rotating member insertion hole 1531d-2 can be provided at various positions on the upper portion of the side part 1531d to allow rotation of the center rotating member 1532.

The side part 1531d may include a pressure plate insertion hole 1531d-3. One side of the pressure plate insertion hole 1531d-3 can be hinge-coupled to allow rotation of the pressure plate 1540. The pressure plate insertion hole 1531d-3 can be provided at various positions on the side part 1531d to allow contact between the sensor 1520 and the pressure plate 1540 when the other side of the pressure plate 1540 rotates upward or downward (see FIG. 16 and FIG. 17). For example, the pressure plate insertion hole 1531d-3 can be provided at the lower front portion (see FIG. 16) or the upper front portion (see FIG. 17) of the side part 1531d.

One of the side parts 1531d protruding from both sides of the base part 1531c may include a fixed piece 1531d-4 bent towards the other side part 1531d. However, it is also possible to separately manufacture fixed pieces 1531d-4 and combine the fixed pieces to both side parts 1531d. When the center rotating member 1532 rotates and contacts the fixed piece 1531d-4, the end of the center rotating member 1532 and the fixed piece 1531d-4 can be secured by a fastening member.

The side part 1531d may include a center bushing receiving groove 1531d-5. The center bushings 1311 and 1321 can be rotatably fitted into the center bushing receiving groove 1531d-5. The center bushing receiving groove 1531d-5 may, for example, be formed by cutting the upper end of the side part 1531d.

The center rotating member 1532 can be hinge-coupled to the side part 1531d to be rotatable. The center rotating member 1532 may include a center bushing fixing groove 1532d. When the center rotating member 1532 rotates and is secured to the fixed piece 1531d-4 of the side part 1531d, the center bushing fixing groove 1532d can support the center bushings 1311 and 1321 together with the center bushing receiving groove 1531d-5.

The pressure plate 1540 can be hinge-coupled to the center support bracket 1530 to be rotatable. The pressure plate 1540 may include an elastic member 1541. The elastic member 1541 can apply elastic force to the pressure plate 1540 to rotate the free end of the pressure plate 1540 away from the sensor 1520. The elastic member 1541 can be made of various materials that can provide elastic force to the pressure plate 1540. For example, the elastic member 1541 may be a torsion spring. When the elastic member 1541 is a torsion spring, both ends of the torsion spring can contact at least one of the pressure plate 1540 and the center support bracket 1530 when the pressure plate 1540 rotates.

The elastic member 1541 can prevent the pressure plate 1540 from rotating when the user's body or other objects are not caught between the leg massage part 1300 and between the leg massage part 1300 and the body massage part 1100.

The pressure plate 1540 can rotate and come into contact with the sensor 1520. For example, when an external force greater than the elastic force of the elastic member 1541 is applied to the pressure plate 1540, the pressure plate 1540 can rotate and come into contact with the sensor 1520.

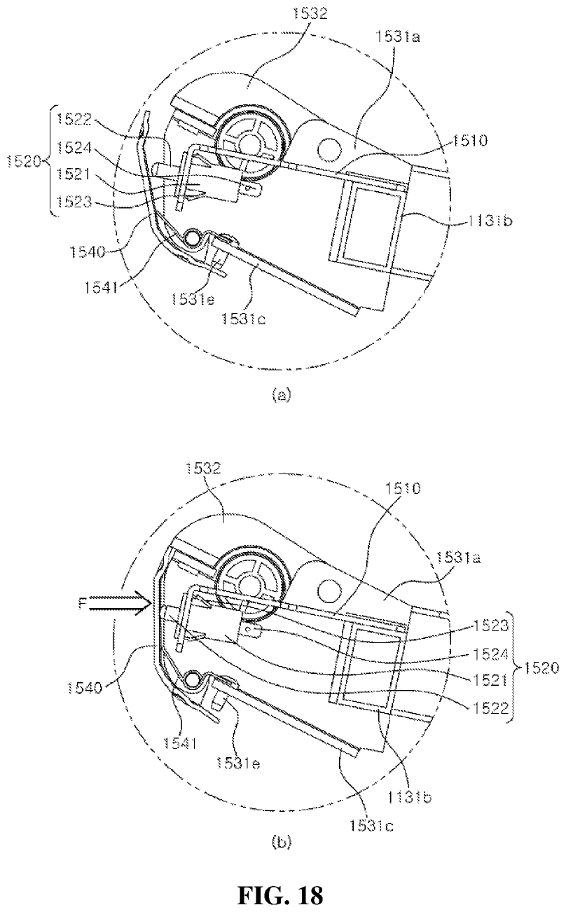

FIGS. 18a and 18b are views illustrating an operation process of the safety sensor module according to an embodiment of the present invention.

Referring to FIG. 18a, due to the elastic force of the elastic member 1541, one end of the pressure plate 1540 may be arranged to be spaced apart from the sensor 1520, and the other end of the pressure plate may be in contact with the stopper 1531e. As the elastic force continues to act on the pressure plate 1540, if a certain external force is not applied for a certain period of time, one end of the pressure plate 1540 may not come into contact with the sensor 1520.

Referring to FIG. 18b, when the user's body is trapped between the leg massage parts 1300 and/or between the leg massage part 1300 and the body massage part 1100 and at least one of the leg massage part 1300 and the body massage part 1100 moves, an external force (F) greater than the elastic force of the elastic member 1541 may be applied to the pressure plate 1540. Furthermore, as long as the trapping state is not released, the external force (F) continues to act on the pressure plate 1540. In this case, the pressure plate 1540 rotates, and one end may come into contact with the sensor 1520. When the pressure plate 1540 contacts the sensor 1520, the sensor 1520 can transmit the corresponding information to the control unit 1400. Upon receiving the information that the pressure plate 1540 is in contact from the sensor unit 1520, the control unit 1400 can control the operation of at least one of the first leg massage part 1310, the second leg massage part 1330, and the body massage part 1100 or activate an alarm unit. Therefore, it is possible to prevent accidents that may occur when the user's body is caught between the leg massage parts 1300 and/or between the leg massage part 1300 and the body massage part 1100.

In addition, the present invention can prevent equipment malfunction and damage that may occur when objects other than the user's body are caught between the leg massage part 1300 or between the leg massage part 1300 and the body massage part 1100.

Although the present invention has been described with reference to exemplary embodiments along with the accompanying drawings, it should be understood that this is merely exemplary and not intended to limit the present invention. Furthermore, it is evident to those skilled in the art that various modifications and variations can be made within the scope of the technical concept of the present invention without departing from the scope thereof.

Additionally, the configuration and functions of the massage device in this specification can be expanded and applied to various (wearable) healthcare devices capable of providing healthcare functions (e.g., massage functions, biometric signal measurement functions, etc.). Therefore, the term ‘massage device’ in this specification can be replaced with ‘(wearable) healthcare device’ as well.

1. A massage device comprising:
a leg connection frame;
a first leg massage part connected to the leg connection frame in a rotatable manner and accommodating one leg of a user;
a second leg massage part connected to the leg connection frame to be spaced apart from the first leg massage part, provided to be rotated independently from the first leg massage part, and accommodating the other leg of the user;
a center support bracket provided on the leg connection frame, rotatably supporting the inner side of the first leg massage part and the inner side of the second leg massage part; and
a side support bracket provided on the leg connection frame, rotatably supporting the outer side of the first leg massage part and the outer side of the second leg massage part.

2. The massage device according to claim 1, wherein the first leg massage part includes a first center bushing rotatably inserted and coupled to the center support bracket and a first side bushing rotatably inserted and coupled to the side support bracket, and
wherein the second leg massage part includes a second center bushing rotatably inserted and coupled to the center support bracket and a second side bushing rotatably inserted and coupled to the side support bracket.

3. The massage device according to claim 2, wherein the center support bracket comprises:
a center fixing member connected to the leg connection frame and provided with a center bushing receiving groove; and
a center rotating member rotatably provided on the center fixing member and provided with a center bushing fixing groove corresponding to the center bushing receiving groove, and
wherein the side support bracket comprises:
a side fixing member connected to the leg connection frame and provided with a side bushing receiving groove; and
a side rotating member rotatably provided on the side fixing member and provided with a side bushing fixing groove corresponding to the side bushing receiving groove.

4. The massage device according to claim 3, wherein the first center bushing and the second center bushing are rotatably arranged within a space formed by the center bushing receiving groove and the center bushing fixing groove, and
wherein the first side bushing and the second side bushing are rotatably arranged within a space formed by the side bushing receiving groove and the side bushing fixing groove.

5. The massage device according to claim 3, wherein the center fixing member comprises:
a base part forming the bottom surface; and
side parts bent and protruding from both sides of the base part, and
wherein each of the side parts includes:
a leg connection frame insertion hole of which one side end facing the leg connection frame is cut to allow the leg connection frame to be inserted; and
a center rotating member insertion hole to which the center rotating member is rotatably hinged.

6. The massage device according to claim 2, wherein the first leg massage part comprises:
a first leg frame provided with a first shaft housing inside; and
a first shaft of which both end portions penetrate the first shaft housing to be exposed to the outside of the first leg frame and are coupled to the first shaft housing,
wherein the first center bushing is coupled to one end of the first shaft, and the first side bushing is coupled to the other end of the first shaft,
wherein the second leg massage part comprises:
a second leg frame provided with a second shaft housing inside; and
a second shaft of which both end portions penetrate the second shaft housing to be exposed to the outside of the second leg frame and are coupled to the second shaft housing,
wherein the second center bushing is coupled to one end of the second shaft, and the second side bushing is coupled to the other end of the second shaft.

7. The massage device according to claim 2, wherein on the outer peripheral surface of the first center bushing, a first center support rib for preventing separation of the center support bracket protrudes radially outward,
on the outer peripheral surface of the first side bushing, a first side support rib for preventing separation of the side support bracket protrudes radially outward,
on the outer peripheral surface of the second center bushing, a second center support rib for preventing separation of the center support bracket protrudes radially outward, and
on the outer peripheral surface of the second side bushing, a second side support rib for preventing separation of the side support bracket protrudes radially outward.

8. The massage device according to claim 7, wherein bearings are coupled on the outer peripheral surfaces of the first center bushing, the first side bushing, the second center bushing, and the second side bushing where the first center support rib, the first side support rib, the second center support rib, and the second side support rib are not formed, and
wherein the bearings are supported by the center support bracket and the side support bracket.

9. The massage device according to claim 2, wherein the first center bushing, the first side bushing, the second center bushing, and the second side bushing include at least one of Polyacetal and glassfiber.

10. The massage device according to claim 3, wherein the center rotating member is rotatably hinge-coupled to the center fixing member through a center rotation axis, and the side rotating member is rotatably hinge-coupled to the side fixing member through a side rotation axis, and
wherein the center rotation axis is integrally provided with the center rotating member or the center fixing member, and the side rotation axis is integrally provided with the side rotating member or the side fixing member.

11. The massage device according to claim 1, wherein when external force is applied to the inside of the center support bracket, a safety sensor module is provided which controls the operation of the first leg massage part and the second leg massage part or emits an alarm signal.
